(19) United States
(12) Patent Application Publication
(10) Pub. No.: US 2005/0140571 A1
(43) Pub. Date: Jun. 30, 2005

(54) Device and method for display control, and the like

(75) Inventors: Yoichi Hara, Kawagoe-shi (JP); Yasuhide Homma, Kawagoe-shi (JP); Kazunori Ishizu, Kawagoe-shi (JP); Yuji Takatori, Kawagoe-shi (JP)

Correspondence Address: LADAS & PARRY;Suite #2100, 5670 Wilshire Boulevard, Los Angeles, CA, 90036-5679, US

(73) Assignee: PIONEER CORPORATION

(21) Appl. No.: 11/008,000

(22) Filed: Dec. 8, 2004

(30) Foreign Application Priority Data
Dec. 12, 2003 (JP) P2003-415454

(51) Int. Cl. G09G 5/00

(52) U.S. Cl. 345/3.1

(57) ABSTRACT

A display control device permits a display screen to display predetermined image information. The display control device comprises: a detecting device which receives a signal having a display adjustment signal superimposed thereon, samples a plurality of portions from the display adjustment signals, and detects optimum timing based on a plurality of sampled values, the display adjustment signal being used for adjusting the timing of display of each pixel of the image information, the display adjustment signal being superimposed upon the signal on a horizontal scanning line in a signal portion corresponding to a region outside the display screen; and an adjusting device which adjusts the timing of display of each pixel in accordance with the detected optimum timing.

### BACKGROUND OF THE INVENTION

1. Field of the Invention

The invention relates to the technical field of a display control device and method, and the like which permit a display screen to display predetermined image information.

2. Description of the Related Art

Recently, a display part such as a monitor or a display has displayed an image (or a picture) with higher definition. The approach of making the number of display pixels of the display part equal to the number of pixels of an image signal having image information is adopted as one approach for making full use of display capabilities of the display part. For example, a navigation system includes a graphics part which outputs an image signal having map image information in accordance with the number of display pixels of the display part so that the number of pixels of the image signal is equal to the number of display pixels of the display part, whereby the navigation system provides a clear (or sharp) image (or picture).

However, the problem of a blurred image appearing arises when there is a time lag between the timing of output of an image signal from the graphics part and the timing of display of each pixel on the display part. Thus, an operator almost alone has heretofore performed timing adjustment by manually changing the timing of display of each pixel or the like, while viewing an image displayed on the display part.

Japanese Paten Application Laid-Open No. 2000-122621 discloses a display device capable of matching the timing of display of each pixel on a display part to a display clock signal for regulating the timing of display of each pixel, thereby preventing an image from bleeding or becoming blurred. Specifically, the display device includes a picture generator which outputs a picture signal, in which a fine horizontal adjustment signal for regulating the timing of display of each pixel of a display picture is superimposed on a predetermined horizontal scanning line within a vertical retrace interval corresponding to an out-of-frame region which lies outside a display screen of the display part and does not contribute to the display picture. A comparison is made between a reference voltage and a portion at or near the peak value of the fine horizontal adjustment signal (e.g., a non-square wave), that is, a threshold is taken. The signal is subjected to waveform shaping, and the resulting signal is outputted to act as a HIGH signal. The timing of the display clock signal is adjusted in accordance with the timing of the HIGH signal.

However, the above-mentioned conventional display device has the problem of failing to detect the fine horizontal adjustment signal when the signal does not go above a threshold level due to a decrease in signal-level or the like, because the display device is designed to take a threshold for detecting a portion at or near the peak value of the fine horizontal adjustment signal. On the other hand, a low threshold level leads to the problem of causing a time lag in the peak value of the fine horizontal adjustment signal and thus causing a time lag in the timing of display of each pixel. When the fine horizontal adjustment signal for superimposition is not under strict control, the following problem arises: there is a time lag relative to the threshold level, and thus there is a time lag in the timing of display of each pixel.

These problems arise, for example when a signal delay develops under the influence of the length of a transmission line (e.g., when there is a long extended cable between the graphics part and the display part) or when the transmission line has poor frequency characteristics.

### SUMMARY OF THE INVENTION

The invention is designed to overcome one of the foregoing problems. It is an object of the invention to provide a display control device and method and the like capable of adjusting the timing of display of each pixel with greater precision, thereby displaying a clearer image.

The invention of claim 1 relates to a display control device which permits a display screen to display predetermined image information, comprising:
a detecting device which receives a signal having a display adjustment signal superimposed thereon, samples a plurality of portions from the display adjustment signals, and detects optimum timing based on a plurality of sampled values, the display adjustment signal being used for adjusting the timing of display of each pixel of the image information, the display adjustment signal being superimposed upon the signal on a horizontal scanning line in a signal portion corresponding to a region outside the display screen; and
an adjusting device which adjusts the timing of display of each pixel in accordance with the detected optimum timing.

The invention of claim 22 relates to a display control method which permits a display screen to display predetermined image information, comprising:
a detecting process which receives a signal having a display adjustment signal superimposed thereon, samples at least one portion from the display adjustment signal, and detects optimum timing based on the sampled value, the display adjustment signal being used for adjusting the timing of display of each pixel of the image information, the display adjustment signal being superimposed upon the signal on a horizontal scanning line in a signal portion corresponding to a region outside the display screen; and
an adjusting process which adjusts the timing of display of each pixel in accordance with the detected optimum timing.

The invention of claim 23 relates to a recording medium which records a computer-readable display control program which runs on a computer which permits a display screen to display predetermined image information,
the display control program which permits the computer to execute a display control method comprising:
a detecting process which receives a signal having a display adjustment signal superimposed thereon, samples at least one portion from the display adjustment signal, and detects optimum timing based on the sampled value, the display adjustment signal being used for adjusting the timing of display of each pixel of the image information, the display adjustment signal being superimposed upon the signal on a horizontal scanning line in a signal portion corresponding to a region outside the display screen; and
an adjusting process which adjusts the timing of display of each pixel in accordance with the detected optimum timing.

### BRIEF DESCRIPTION OF THE DRAWINGS

FIG. 1 is a schematic block diagram showing an example of a display control device included in a car navigation system according to a first embodiment of the invention;

FIG. 2 is a conceptual illustration showing the relation between regions inside and outside a display screen of a display part 5 and an image signal (e.g., an R-component image signal);

FIG. 3 is a flowchart showing the flow of processing which a display control device SX1 performs;

FIG. 4 is an illustration showing an example of the sampling timing and the optimum timing of a display adjustment signal for use in an example 1;

FIGS. 5A to 5D are conceptual illustrations showing an example of the relation between the phases of an image signal and a clock signal for use in the example 1;

FIG. 6 is an illustration showing an example of the sampling timing and the optimum timing of a display adjustment signal for use in an example 2;

FIGS. 7A to 7D are conceptual illustrations showing an example of the relation between the phases of an image signal and a clock signal for use in the example 2;

FIG. 8 is an illustration showing an example of the sampling timing and the optimum timing of a display adjustment signal for use in an example 3;

FIG. 9 is an illustration showing another example of the sampling timing and the optimum timing of the display adjustment signal for use in the example 3;

FIG. 10 is an illustration showing an example of the sampling timing and the optimum timing of a display adjustment signal for use in an example 4;

FIG. 11 is an illustration showing another example of the sampling timing and the optimum timing of the display adjustment signal for use in the example 4;

FIG. 12 is a schematic block diagram showing an example of a display control device included in a car navigation system according to a second embodiment of the invention; and

FIG. 13 is a flowchart showing the flow of processing which a display control device SX2 performs.

### DETAILED DESCRIPTION OF THE PREFERRED EMBODIMENTS

Preferred embodiments of the invention will be described below with reference to the accompanying drawings. Incidentally, the embodiments mentioned below are the embodiments of the invention as applied to a car navigation system.

### First Embodiment

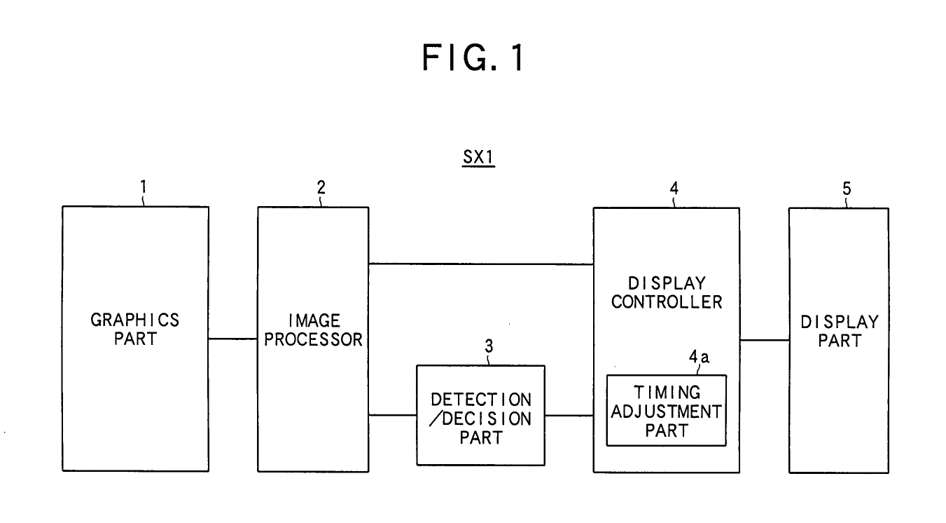

Firstly, the description is given with reference to FIG. 1 and other drawings with regard to the configuration and functions of a display control device included in a car navigation system according to a first embodiment of the invention.

FIG. 1 is a schematic block diagram showing an example of the display control device included in the car navigation system according to the first embodiment.

As shown in FIG. 1, a display control device SX1 according to the first embodiment includes a graphics part 1 which acts as an example of a display adjustment signal superimposing device, an image (or picture) processor 2, a detection/decision part 3 which acts as an example of a detecting device, a display controller 4 having a timing adjustment part 4a which acts as an example of an adjusting device, and a display part 5 such as a liquid crystal display.

Incidentally, the car navigation system includes a GPS (Global Positioning System) receiver which receives radio waves sent from a GPS satellite and detects current position information (e.g., latitude and longitude); a sensor part including a speed sensor, an accelerometer, a gyro-sensor, and the like; an operating part which accepts an operation command from a driver or the like; a storage part which stores various types of information such as map information; and a controller which performs known navigation (such as routing or map matching) based on detection information detected by the GPS receiver and the sensor part and driver's or other command information accepted by the operating part, although these parts are not shown.

The graphics part 1 generates a signal for displaying image (or picture) information (i.e., image information to be displayed on a display screen of the display part 5) containing map information under the command of the controller of the car navigation system, such as an image (or picture) signal corresponding to each of RGB color components. When generating the image signals, the graphics part 1 superimposes a display adjustment signal (e.g., a square-wave signal) for adjusting the timing of display of each pixel of the image information upon, for example, the R-component image signal on a horizontal scanning line in a signal portion which corresponds to a region outside the display screen of the display part 5 and also corresponds to a region capable of displaying the image information.

The description is now given with regard to the relation between the regions inside and outside the display screen of the display part 5 and the image signal.

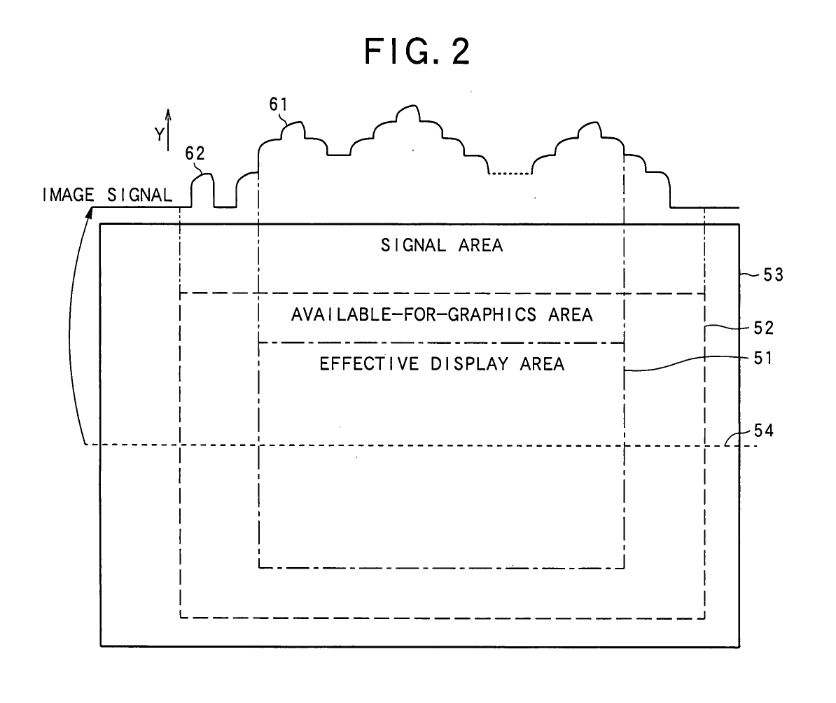

FIG. 2 is a conceptual illustration showing an example of the relation between the regions inside and outside the display screen of the display part 5 and the image signal (e.g., the R-component image signal). In FIG. 2, there are shown a signal area 53, an available-for-graphics area 52, and an effective display area 51. The signal area 53 contains the available-for-graphics area 52 and the effective display area 51, and the available-for-graphics area 52 contains the effective display area 51.

The effective display area 51 is the region which corresponds to the display screen region of the display part 5 and actually displays image information.

The available-for-graphics area 52 is the region capable of displaying image information. Specifically, a region lying both outside the effective display area 51 and inside the available-for-graphics area 52 does not display image information, because the actual display screen region lies within the effective display area 51. However, the display part 5having a larger display screen region enables the available-for-graphics area 52 to display image information. In other words, the region lying both outside the effective display area 51 and inside the available-for-graphics area 52 corresponds to the region outside the display screen and also corresponds to the region capable of displaying image information.

A region lying both outside the available-for-graphics area 52 and inside the signal area 53 is the region which does not contribute to a display image (i.e., the region incapable of displaying image information).

An image signal outside and above the signal area 53 shown in FIG. 2 is an example of a signal on a horizontal scanning line 54 extending across the signal area 53, the available-for-graphics area 52, and the effective display area 51 along substantially the center line of these areas. The vertical direction (i.e., the Y direction) indicates the intensity of brightness of each pixel. The image signal has each pixel signal 61 in a signal portion corresponding to the effective display area 51.

The image signal has each pixel signal 61 and a display adjustment signal 62 in a signal portion corresponding to the available-for-graphics area 52. In other words, the display adjustment signal 62 is superimposed on a signal portion corresponding to the region lying both outside the effective display area 51 and inside the available-for-graphics area 52. Since a region within the available-for-graphics area 52 corresponds to a signal portion for generating the image signal, the graphics part 1 can superimpose the display adjustment signal 62 on this signal portion.

The image signal has neither each pixel signal 61 nor the display adjustment signal 62 in a signal portion corresponding to the region lying both outside the available-for-graphics area 52 and inside the signal area 53. This signal portion contains horizontal and vertical retrace intervals.

As shown in FIG. 2, each pixel signal 61 and the display adjustment signal 62 have so-called rounding having a gradual rising edge. This results from, for example, the influence of the length of a transmission line (e.g., in the car navigation system, a cable between the graphics part land the image processor 2 or between the image processor 2 and the detection/decision part 3 may be as long as 1 to 6 m), the influence of frequency characteristics of the transmission line, or the like.

The image signal generated as mentioned above is outputted in conjunction with a synchronization signal to the image processor 2.

The image processor 2 performs known image (or picture) processing (such as brightness adjustment or contrast adjustment) on the image signal corresponding to each of the RGB color components from the graphics part 1, and outputs the processed image signal to the detection/decision part 3. Moreover, the image processor 2 separates the synchronization signal from the graphics part 1 into a horizontal synchronization signal and a vertical synchronization signal, and outputs the horizontal and vertical synchronization signals to the display controller 4. The horizontal synchronization signal is provided on a starting point of each of all horizontal scanning lines including the horizontal scanning line 54 in the region lying both outside the available-for-graphics area 52 and inside the signal area 53. The vertical synchronization signal is provided on a top end point in the region lying both outside the available-for-graphics area 52 and inside the signal area 53.

The detection/decision part 3 outputs the image signal from the image processor 2 to the display controller 4. Moreover, the detection/decision part 3 samples a plurality of portions from the display adjustment signal 62 superimposed on the image signal in accordance with predetermined sampling timing, and detects optimum timing based on a plurality of sampled values. There are various approaches for detecting the optimum timing, which will be described in detail later.

Upon receipt of input of the image signal, the horizontal and vertical synchronization signals, and various types of timing control signals, the display controller 4 outputs these input signals to the display part 5. Moreover, the display controller 4 generates a clock signal for regulating the timing of display of each pixel of the image information, and outputs the clock signal to the display part 5 (in other words, the display screen of the display part 5 displays the image information under control of the display controller 4). In this case, the timing (i.e., dot clock timing) adjustment part 4a of the display controller 4 adjusts the timing of display of each pixel of the image information in accordance with the detected optimum timing (i.e., a dot clock phase adjustment signal).

The display part 5 includes a liquid crystal panel having the display screen, a horizontal driver, and a vertical driver. The display part 5 provides display of each pixel of the image information contained in the image signal by using the horizontal and vertical drivers to drive, for example, pixels on each line on the liquid crystal panel in synchronization with the clock signal.

### EXAMPLES

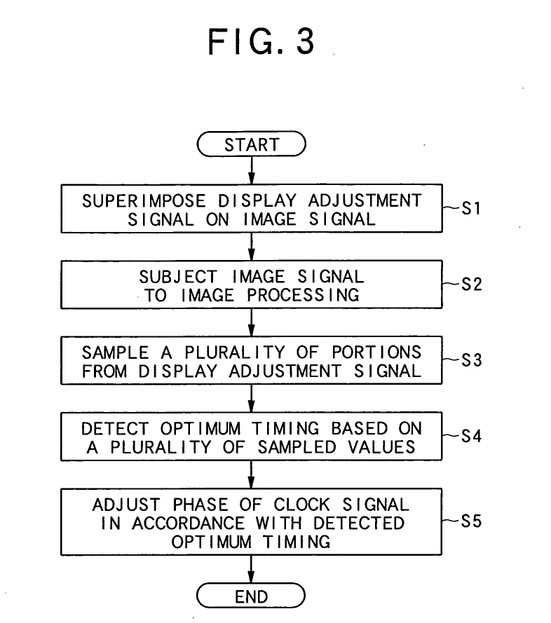

Next, the description is given in the sections “Example 1” to “Example 4” with reference to FIG. 3 and other drawings with regard to the operation of the display control device SX1 having the above-mentioned configuration. FIG. 3 is a flowchart showing the flow of processing which the display control device SX1 performs (incidentally, the flowchart of FIG. 3 is common to the examples 1 to 4).

### Example 1

Referring to FIG. 3, the graphics part 1 generates image information containing map information under the command of the controller (not shown) of the car navigation system, for example, as an image signal corresponding to each of RGB color components. The graphics part 1 also superimposes the display adjustment signal 62 (e.g., a square-wave signal) upon, for example, the R-component image signal on the horizontal scanning line 54 in the signal portion which corresponds to the region outside the display screen of the display part 5 and also corresponds to the region capable of displaying the image information (step S1). The graphics part 1 outputs to the image processor 2 the image signal in conjunction with the synchronization signal.

Because of pre-recognition of the range (e.g., 480×234 dots) of the effective display area 51 of the display part 5, the graphics part 1 can superimpose the display adjustment signal 62 on the image signal in the signal portion corresponding to the region lying both outside the effective display area 51 and inside the available-for-graphics area 52.

The display adjustment signal 62 is the signal in synchronization with a display pixel (i.e., a dot on the display screen). In the first embodiment, the display adjustment signal 62 is the signal corresponding to one display pixel, because this embodiment provides an example in which one graphic dot is composed of one display pixel. However, the display adjustment signal 62 is the signal corresponding to two display pixels, for example, when one graphic dot is composed of two display pixels.

Upon receipt of the image signal and the synchronization signal from the graphics part 1, the image processor 2 then subjects the image signal to known image processing (step S2), and outputs the processed image signal to the detection/decision part 3. Moreover, the image processor 2 separates the synchronization signal into the horizontal and vertical synchronization signals, and outputs the horizontal and vertical synchronization signals to the display controller 4.

Upon receipt of the image signal from the image processor 2, the detection/decision part 3 then outputs the input image signal to the display controller 4. Moreover, the detection/decision part 3 samples a plurality of portions from the display adjustment signal 62 superimposed on the image signal (step S3). The detection/decision part 3 detects as the optimum timing, the timing of the display adjustment signal 62 having, for example, the maximum value of a plurality of sampled values (step S4). The detection/decision part 3 outputs to the display controller 4 the dot clock phase adjustment signal indicative of the optimum timing.

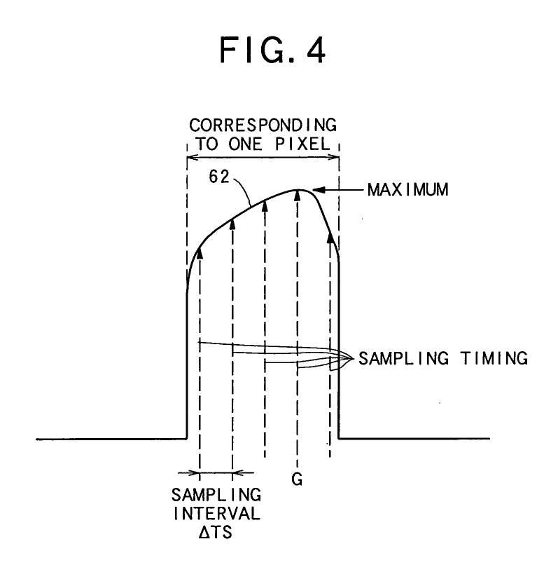

FIG. 4 is an illustration showing an example of the sampling timing and the optimum timing of the display adjustment signal for use in the example 1. As shown in FIG. 4, the display adjustment signal 62 is sampled at sampling intervals (or time), each of which is shorter than the time interval of the display adjustment signals 62. In the example shown in FIG. 4, the timing of the display adjustment signal 62 having the maximum value “G” of five sampled values is detected for detection of the optimum timing. The sampling interval may be fixed or appropriately settable by the operating part or the like.

In this example, the detection/decision part 3 is configured to detect the timing of the display adjustment signal having the maximum value of a plurality of sampled values for detection of the optimum timing, because the display control device SX1 is configured so that the display adjustment signal 62 having the maximum value is inputted to the detection/decision part 3. However, the detection/decision part 3 is configured to detect the timing of the display adjustment signal 62 having the minimum value of a plurality of sampled values for detection of the optimum timing, for example, when the display control device SX1 is configured so that the display adjustment signal having the minimum value is inputted to the detection/decision part 3 (such as when the display control device SX1 is configured so that the display adjustment signal 62 is inverted by an inverter or the like or so that the inverted display adjustment signal 62 is superimposed).

Upon receipt of the image signal, the horizontal and vertical synchronization signals, and other signals from the image processor 2 and the detection/decision part 3, the display controller 4 then outputs these input signals to the display part 5. Moreover, the timing adjustment part 4a adjusts the phase of the clock signal in accordance with the clock phase adjustment signal from the detection/decision part 3 in order to bring the clock signal into synchronization with the timing of each pixel signal 61 having the maximum value (step S5). The display controller 4 outputs the clock signal to the display part 5.

More specifically, the timing adjustment part 4a adjusts the phase of the clock signal so that the clock signal is eventually in synchronization with the timing of each pixel signal 61 having the maximum value (i.e., the timing of each pixel having optimum or more optimum brightness).

In other words, the timing of the display adjustment signal 62 having the maximum value can be used as reference timing to bring the clock signal into synchronization with the timing of each pixel signal 61 having the maximum value. The reason is as follows. Each pixel signal 61 and the display adjustment signal 62 have the same or similar rounding, since the signals 61 and 62 are affected in the same or similar manner by, for example, the length of the transmission line, the frequency characteristics of the transmission line, or the like. Moreover, the time interval between the rising edge of each pixel signal 61 and the timing of each pixel signal 61 having the maximum amplitude can be necessarily about the same as the time interval between the rising edge of the display adjustment signal 62 and the timing of the display adjustment signal 62 having the maximum amplitude, since the time interval between the pixel signals 61 is the same as the time interval between the display adjustment signals 62.

Then, the display part 5 receives the clock signal in synchronization with the timing of each pixel signal 61, of the image information contained in the image signal, having the maximum value. The horizontal and vertical drivers drive the pixels on each line on the liquid crystal panel in synchronization with the clock signal. Thus, the display screen of the liquid crystal panel displays clear image information.

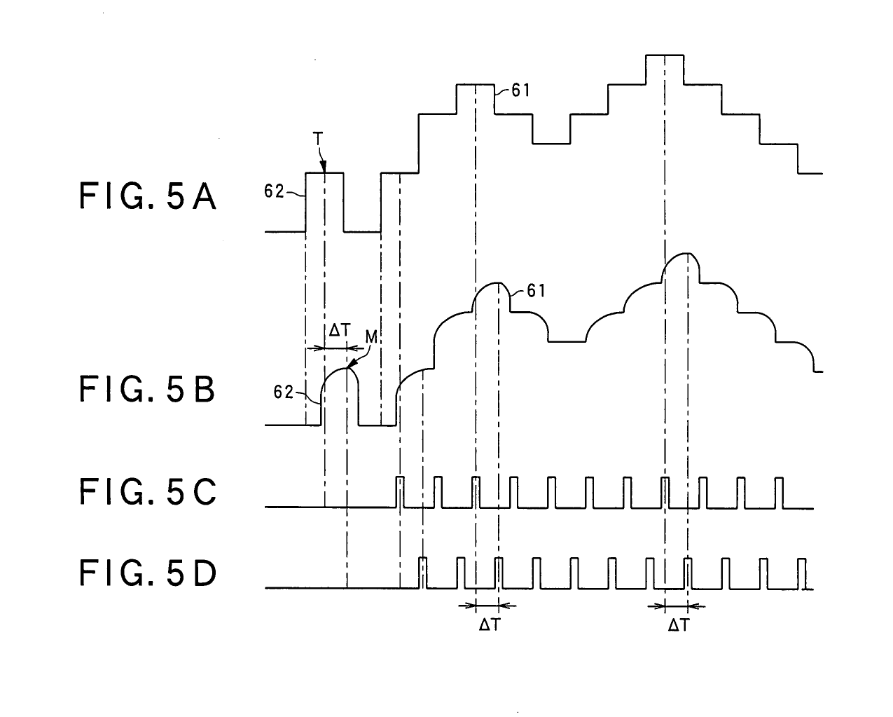

FIGS. 5A to 5D are conceptual illustrations showing an example of the relation between the phases of the image signal and the clock signal for use in the example 1. FIG. 5A shows each pixel signal 61 and the display adjustment signal 62 which appear immediately after being outputted by the graphics part 1. FIG. 5B shows each pixel signal 61 and the display adjustment signal 62 which appear immediately before being inputted to the display controller 4. FIG. 5C shows the clock signal which appears before the timing adjustment part 4a subjects the clock signal to phase adjustment. FIG. 5D shows the clock signal which appears after the timing adjustment part 4a subjects the clock signal to phase adjustment.

Immediately after being outputted by the graphics part 1, each pixel signal 61 and the display adjustment signal 62 do not have rounding or the like, but have respective flat peaks, as shown in FIG. 5A. Immediately before being inputted to the display controller 4, each pixel signal 61 and the display adjustment signal 62 are rounded and delayed under the influence of, for example, the length of the transmission line, the frequency characteristics of the transmission line, or the like, as shown in FIG. 5B. For example, provided that a center point T of the display adjustment signal 62 shown in FIG. 5A is a reference point of the display adjustment signal 62, a phase difference (or shift) between the reference point T and a maximum point M of the displayed adjustment signal 62 shown in FIG. 5B is equivalent to ΔT. The same holds true for each pixel signal 61.

Before undergoing phase adjustment, the clock signal is in synchronization with the timing at which each pixel signal 61 appearing immediately after being outputted by the graphics part 1 has the maximum value, but the clock signal is out of synchronization with the timing at which each pixel signal 61 appearing immediately before being inputted to the display controller 4 has the maximum value. After undergoing phase adjustment, the clock signal, however, is in synchronization with the timing at which each pixel signal 61 appearing immediately before being inputted to the display controller 4 has the maximum value. In short, the unadjusted clock signal shown in FIG. 5C is changed as shown in FIG. 5D through adjustment which involves shifting the phase of the unadjusted clock signal by ΔT equivalent to the above-mentioned phase difference (i.e., the phase difference between the timing of the reference point of the display adjustment signal and the detected optimum timing). (In other words, the timing of display of each pixel is shifted for adjustment.)

As described above, the display control device SX1 of the above-mentioned example 1 is configured to perform the processing which includes the steps of: sampling a plurality of portions from the display adjustment signal superimposed on the image signal; detecting the timing of the display adjustment signal having the maximum or minimum value of a plurality of sampled values, thereby detecting the optimum timing; and adjusting the timing of display of each pixel of the image information in accordance with the detected optimum timing. Therefore, the display control device SX1 enables a more exact match between the timing of output of the image signal from the graphic part 1 and the timing of display of each pixel on the display part, and thus enables displaying a clearer image, even when the image signal is delayed or is rounded or otherwise distorted under the influence of, for example, the length of the transmission line, the frequency characteristics of the transmission line, or the like. Moreover, the display control device SX1 allows sampling a plurality of portions from a 1-pulse display adjustment signal in synchronization with a graphic dot, and thus enables detecting the optimum timing with greater precision.

### Example 2

In the above-mentioned example 1, the detection/decision part 3 detects the optimum timing by detecting the timing of the display adjustment signal having the maximum or minimum value of a plurality of sampled values. On the other hand, in the example 2, the detection/decision part 3 detects the optimum timing through the procedure which involves detecting the timing of the display adjustment signal having the maximum or minimum value, and detecting the timing at which the display adjustment signal is shifted in phase from the detected timing by a predefined amount of offset.

The timing at which the display adjustment signal is shifted in phase by the amount of offset is used as the optimum timing as mentioned above, because it may be inappropriate to use as the optimum timing the detected timing of the display adjustment signal having the maximum or minimum value, for example in the following situations: (i) where an image signal is delayed between the display controller 4 and the display part 5; (ii) where an image signal is delayed when the image signal is temporarily stored in a memory or the like in the display part 5 or the like; and (iii) where the display controller 4 has the amount of jitter near an adjacent pixel at the timing of the display adjustment signal having the maximum or minimum value.

The amount of offset is set to the optimum value according to the device in consideration of the above situations (i) to (iii) and others. The amount of offset may be set to a positive or negative value.

The processing shown in FIGS. 5A to 5D is applied to processing which the display control device SX1 of the example 2 performs. Since steps S1 to S3 shown in FIG. 3 take place as in the case of the example 1, the repeated description of these steps is omitted.

In step S4 of the example 2, the detection/decision part 3 detects the optimum timing through the procedure which involves detecting the timing of the display adjustment signal having the maximum (or minimum) value of a plurality of sampled values, and detecting the timing at which the display adjustment signal is shifted in phase from the detected timing by a predefined amount of offset. The detection/decision part 3 outputs to the display controller 4 the dot clock phase adjustment signal indicative of the detected optimum timing.

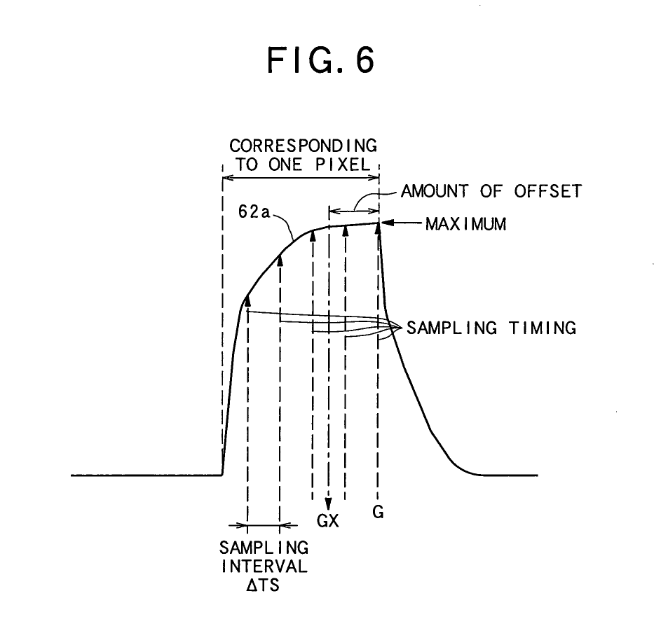

FIG. 6 is an illustration showing an example of the sampling timing and the optimum timing of the display adjustment signal for use in the example 2. In the example shown in FIG. 6, timing GX shifted by the amount of offset from the timing of the display adjustment signal having the maximum value “G” of five sampled values is detected for detection of the optimum timing. The sampling interval may be fixed or appropriately settable by the operating part or the like.

In step S5, upon receipt of the image signal and the horizontal and vertical synchronization signals from the image processor 2 and the detection/decision part 3, the display controller 4 then outputs these input signals to the display part 5. Moreover, the timing adjustment part 4a adjusts the phase of the clock signal in accordance with the clock phase adjustment signal from the detection/decision part 3 in order to bring the clock signal into synchronization with the timing shifted by the amount of offset from the timing of each pixel signal 61 having the maximum value. The display controller 4 outputs the clock signal to the display part 5.

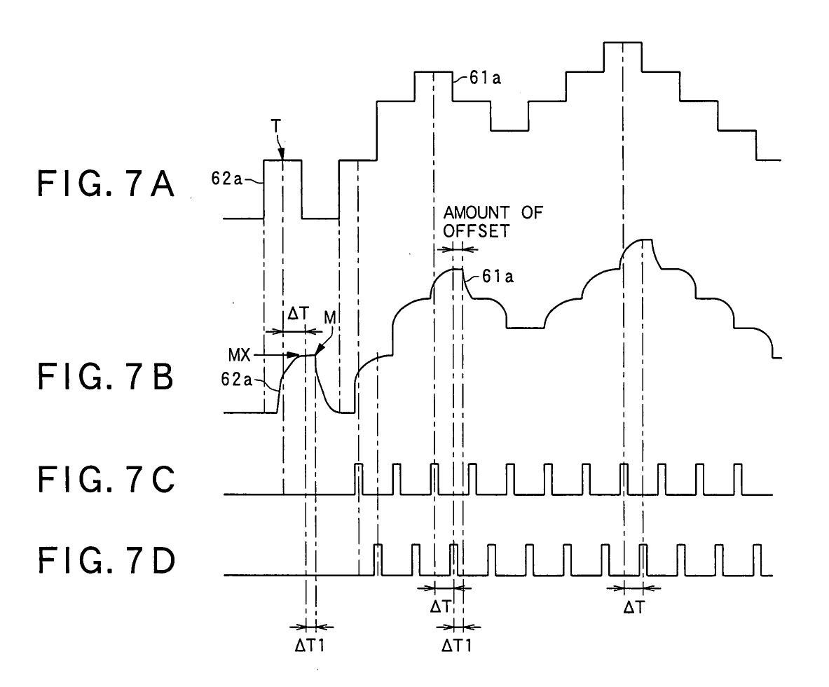

FIGS. 7A to 7D are conceptual illustrations showing an example of the relation between the phases of the image signal and the clock signal for use in the example 2. FIG. 7A shows the image signal (i.e., each pixel signal 61a and a display adjustment signal 62a) which appears immediately after being outputted by the graphics part 1, similarly to FIG. SA. FIG. 7B shows the image signal (i.e., each pixel signal 61a and the display adjustment signal 62a) which appears immediately before being inputted to the display controller 4, similarly to FIG. 5B. FIG. 7C shows the clock signal which appears before the timing adjustment part 4a subjects the clock signal to phase adjustment, similarly to FIG. 5C. FIG. 7D shows the clock signal which appears after the timing adjustment part 4a subjects the clock signal to phase adjustment, similarly to FIG. 5D.

In the example 2, as shown in FIGS. 7A to 7D, for example provided that the center point T of the display adjustment signal 62a shown in FIG. 7A is the reference point of the display adjustment signal 62a, the unadjusted clock signal shown in FIG. 7C is changed into the clock signal shown in FIG. 7D through adjustment which involves shifting the phase of the unadjusted clock signal by a phase difference ΔT between the reference point T and an optimum point MX shifted by the amount AT1 of offset from the maximum point M of the display adjustment signal 62a shown in FIG. 7B.

As described above, the display control device SX1 of the above-mentioned example 2 is configured to perform the processing which includes the steps of: sampling a plurality of portions from the display adjustment signal superimposed on the image signal; detecting the timing of the display adjustment signal having the maximum or minimum value of a plurality of sampled values, and detecting the timing at which the display adjustment signal is shifted in phase from the detected timing by a predefined amount of offset, thereby detecting the optimum timing; and adjusting the timing of display of each pixel of the image information in accordance with the detected optimum timing. Therefore, the display control device SX1 of the example 2 enables a more exact match between the timing of output of the image signal from the graphics part land the timing of display of each pixel on the display part, and thus enables displaying a clearer image, even when the image signal is delayed or is rounded or otherwise distorted under the influence of, for example, the length of the transmission line, the frequency characteristics of the transmission line, or the like, and moreover when it is not appropriate to use as the optimum timing the timing of the display adjustment signal having the maximum or minimum value under the influence of the above situations (i) to (iii) and so on (e.g., when an adjacent pixel is subjected to display sampling using the clock signal when the display controller 4 has the amount of jitter as mentioned above).

When the amount of offset is set to “0”, the configuration of the example 2 is equivalent to that of the above-mentioned example 1.

### Example 3

In the above-mentioned examples 1 and 2, the detection/decision part 3 samples a plurality of portions from a 1-pulse signal which is the display adjustment signal, and detects the optimum timing based on a plurality of sampled values. On the other hand, in the example 3, the detection/decision part 3 samples respective portions of a plurality of pulses from a multi-pulse signal, and detects the optimum timing based on a plurality of sampled values.

The processing shown in FIG. 3 is applied to processing which the display control device SX1 of the example 3 performs.

In step S1 of the example 3, after generating image signals, the graphics part 1 superimposes the display adjustment signal having a plurality of repetitions of HIGH and LOW levels upon, for example, the R-component image signal on the horizontal scanning line in the signal portion which corresponds to the region outside the display screen of the display part 5 and also corresponds to the region capable of displaying the image information. The graphics part 1 outputs to the image processor 2 the image signal together with the synchronization signal. In other words, the graphics part 1 superimposes upon the image signal a plurality of 1-pulse display adjustment signals in the examples 1 and 2, (specifically, this signal is the signal in synchronization with a graphic dot, such as the signal corresponding to one display pixel, as in the case of the examples 1 and 2).

Then, step S2 takes place as in the case of the example 1. In step S3, upon receipt of the image signal from the image processor 2, the detection/decision part 3 outputs the input image signal to the display controller 4. Moreover, the detection/decision part 3 samples at least one portion in each High-level interval from the display adjustment signal superimposed on the image signal. The detection/decision part 3 performs sampling, while shifting the sampling timing for each High-level interval by a predetermined interval (e.g., the sampling interval for use in the example 1, shown in FIG. 4).

For example, when the display adjustment signal is inverted by an inverter or the like or the inverted display adjustment signal is superimposed, the detection/decision part 3 samples at least one portion in each Low-level interval from the display adjustment signal. The detection/decision part 3 performs sampling, while shifting the sampling timing for each Low-level interval by a predetermined interval.

Then, in step S4, the detection/decision part 3 operates as in the case of the example 1. Specifically, the detection/decision part 3 detects the optimum timing by detecting the timing of the display adjustment signal having the maximum or minimum value of a plurality of sampled values. The detection/decision part 3 outputs to the display controller 4 the dot clock phase adjustment signal indicative of the detected optimum timing.

As in the case of the example 2, the detection/decision part 3 may be configured to detect the optimum timing through the procedure which involves detecting the timing of the display adjustment signal having the maximum or minimum value of a plurality of sampled values, and detecting the timing at which the display adjustment signal is shifted in phase from the detected timing by a predefined amount of offset.

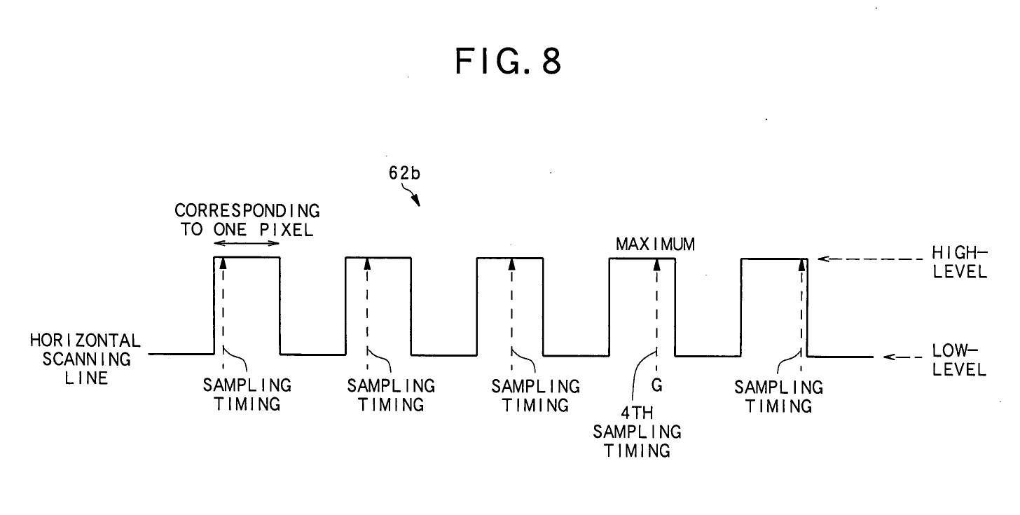

FIG. 8 is an illustration showing an example of the sampling timing and the optimum timing of the display adjustment signal for use in the example 3. In FIG. 8, there is shown a display adjustment signal 62b having no rounding. However, the display adjustment signal 62b actually has rounding in the same manner as the display adjustment signals shown in FIG. 4 and other drawings.

In the example shown in FIG. 8, one portion, in each High-level interval, of the display adjustment signal 62b having five repetitions of HIGH and LOW levels is used as a sampling point. The sampling timing for each High-level interval is shifted by a predetermined interval. For example, the sampling timing G for the fourth HIGH-level is detected for detection of the timing of the display adjustment signal 62b having the maximum value. This approach is equivalent to the approach of sampling a plurality of portions from a 1-pulse display adjustment signal for detection of the timing of the display adjustment signal having the maximum value.

Since step S5 of the example 3 is the same as that of the example 1 or 2, the repeated description of this step is omitted.

As another example, the display control device SX1 may, for example, be configured to execute steps S1 and S3 in the following manner. In step S1, after generating image signals, the graphics part 1 superimposes a plurality of display adjustment signals (for instance, the signal corresponding to one display pixel) upon, for example, the R-component image signal on a plurality of horizontal scanning lines in signal portions which correspond to one screen and also correspond to the region capable of displaying the image information. In step S3, the detection/decision part 3 samples at least one portion from each of the display adjustment signals superimposed upon the signal portion on a plurality of horizontal scanning lines in the above-mentioned signal portions. The detection/decision part 3 may perform sampling, while shifting the sampling timing for each display adjustment signal by a predetermined interval ΔTS. The predetermined interval ΔTS may be fixed or appropriately settable by the operating part or the like.

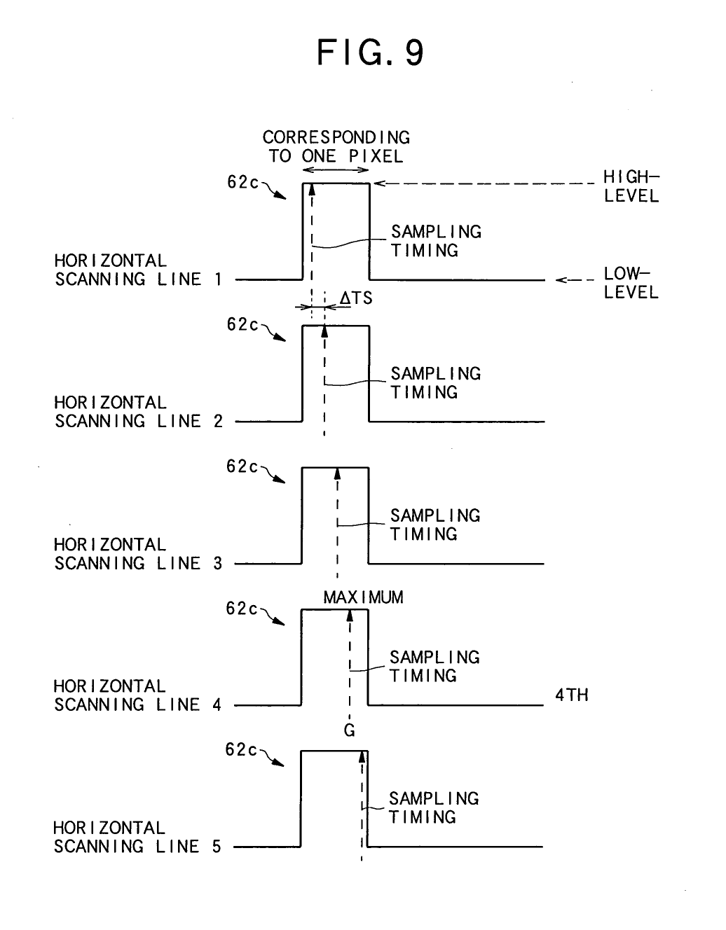

FIG. 9 is an illustration showing another example of the sampling timing and the optimum timing of the display adjustment signal for use in the example 3. In FIG. 9, there is shown a display adjustment signal 62c having no rounding. However, the display adjustment signal 62c actually has rounding in the same manner as the display adjustment signals shown in FIG. 4 and other drawings.

In the example shown in FIG. 9, one portion of each of the display adjustment signals 62c superimposed upon the signal portion on five horizontal scanning lines is used as a sampling point. The sampling timing for each display adjustment signal is shifted by the predetermined interval ΔTS. For example, the sampling timing G for the fourth display adjustment signal 62c is detected for detection of the timing of the display adjustment signal 62c having the maximum value. This approach is equivalent to the approach of sampling a plurality of portions from a 1-pulse display adjustment signal for detection of the timing of the display adjustment signal having the maximum value.

As described above, the display control device SX1 of the above-mentioned example 3 is configured to perform the processing which includes: the step of sampling at least one portion from each of a plurality of display adjustment signals while shifting the sampling timing (i.e., long-interval sampling), rather than the sampling step of the examples 1 and 2, specifically the step of sampling a plurality of portions from the display adjustment signal corresponding to one display pixel (i.e., short-interval sampling); the step of detecting the optimum timing based on a plurality of sampled values; and the step of adjusting the timing of display of each pixel of the image information in accordance with the detected optimum timing. Therefore, the display control device SX1 of the example 3 enables a more exact match between the timing of output of the image signal from the graphics part 1 and the timing of display of each pixel on the display part, and thus enables displaying a clearer image. Moreover, the display control device SX1 of the example 3 can increase the sampling interval or increase the number of samplings, and can thus reduce load on the detection/decision part 3 or the like.

### Example 4

In the above-mentioned examples 1 to 3, the detection/decision part 3 first detects the timing of the display adjustment signal having the maximum or minimum value of a plurality of sampled values, and then detects the optimum timing based on the detected timing. On the other hand, in the example 4, the detection/decision part 3 samples a portion from the display adjustment signal in each of High-level and Low-level intervals having the same interval, then calculates the differential value between the sampled value in the High-level interval and the sampled value in the Low-level interval, and then detects the optimum timing by detecting the timing of the display adjustment signal having the maximum value of a plurality of calculated differential values.

The processing shown in FIGS. 5A to 5D is applied to processing which the display control device SX1 of the example 4 performs.

In step S1 of the example 4, after generating image signals, the graphics part 1 superimposes the display adjustment signal having a plurality of repetitions of HIGH and LOW levels having the same interval upon, for example, the R-component image signal on the horizontal scanning line in the signal portion which corresponds to the region outside the display screen of the display part 5 and also corresponds to the region capable of displaying the image information. The graphics part 1 outputs to the image processor 2 the image signal together with the synchronization signal. In other words, the graphics part 1 superimposes a plurality of 1-pulse display adjustment signals, one of which is used in the examples 1 and 2, (specifically, this signal is the signal in synchronization with a graphic dot, such as the signal corresponding to one display pixel, as in the case of the examples 1 and 2).

Then, step S2 takes place as in the case of the example 1. In step S3, upon receipt of the image signal from the image processor 2, the detection/decision part 3 outputs the input image signal to the display controller 4. Moreover, the detection/decision part 3 performs sampling for each of a plurality of sets of HIGH and LOW levels (i.e., a set of HIGH and LOW levels) so as to sample at least one portion in a High-level interval and a portion distant from the one portion by a given (or preset) interval in a Low-level interval following the High-level interval. The detection/decision part 3 performs sampling, while shifting the sampling timing for each set by a predetermined interval (e.g., the sampling interval for use in the example 1, shown in FIG. 4).

Then, in step S4, the detection/decision part 3 calculates the differential value between the sampled values in the High-level and Low-level intervals of each set, and detects the optimum timing by detecting the timing of the display adjustment signal having the maximum value (i.e., maximum contrast) of a plurality of calculated differential values. The detection/decision part 3 outputs to the display controller 4 the dot clock phase adjustment signal indicative of the detected optimum timing.

As in the case of the example 2, the detection/decision part 3 may be configured to detect the optimum timing through the procedure which involves detecting the timing of the display adjustment signal having the maximum value of a plurality of calculated differential values, and detecting the timing at which the display adjustment signal is shifted in phase from the detected timing by a predefined amount of offset.

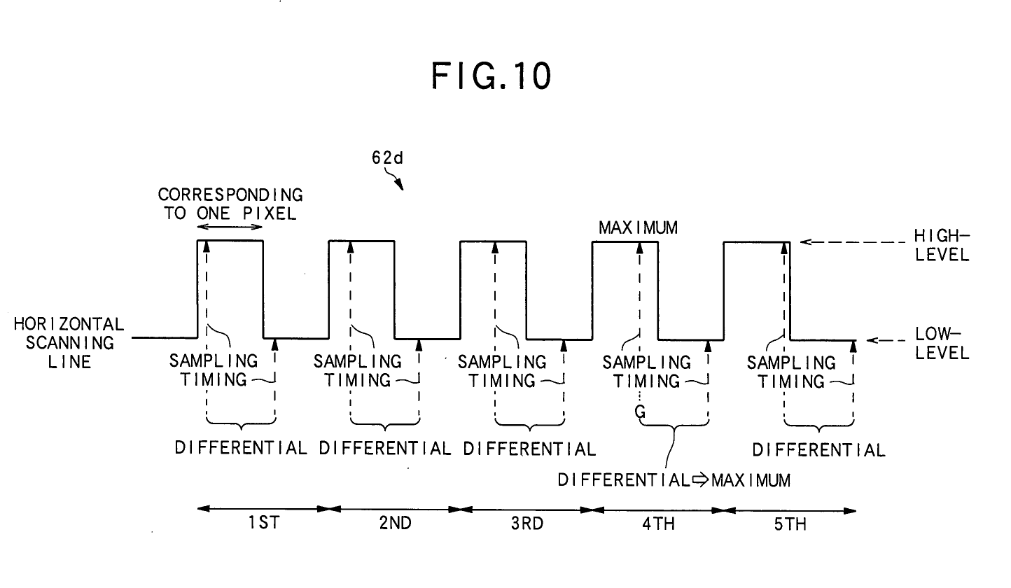

FIG. 10 is an illustration showing an example of the sampling timing and the optimum timing of the display adjustment signal for use in the example 4. In FIG. 10, there is shown a display adjustment signal 62d having no rounding. However, the display adjustment signal 62d actually has rounding in the same manner as the display adjustment signals shown in FIG. 4 and other drawings.

In the example shown in FIG. 10, one portion in each High-level interval and one portion distant from the one High-level portion by a given interval in each Low-level interval following each High-level interval, of the display adjustment signal 62d having five repetitions of HIGH and LOW levels having the same interval, are used as sampling points. For example, as shown in FIG. 10, when one portion in the High-level interval is a point shifted from the rising edge of a pulse by a predetermined interval, one portion in the Low-level interval following the High-level interval is a point shifted from the dropping edge of the pulse by the same interval as the predetermined interval. In other words, in the example 4, the portion distant by the given interval is the point distant by an interval which is equal to the interval between the sampling point in the High-level interval and the dropping edge of the pulse plus the predetermined interval. The sampling timing for each set is shifted by a predetermined interval. For example, the optimum timing is the timing G, and the differential value between the sampled values in the High-level and Low-level intervals of the fourth set is the maximum value (i.e., maximum contrast).

Since step S5 of the example 4 is the same as that of the example 1 or 2, the repeated description of this step is omitted.

As another example, the display control device SX1 may be configured to execute steps S1 and S3 in the following manner. In step S1, after generating image signals, the graphics part 1 superimposes the display adjustment signals each having an inverted signal-level on each horizontal scanning line (for instance, the signal corresponding to one display pixel) upon, for example, the R-component image signal on a plurality of horizontal scanning lines in the signal portions which correspond to one screen and also correspond to the region capable of displaying the image information. In step S3, the detection/decision part 3 samples at least one portion from the display adjustment signal on one horizontal scanning line and also samples a portion from the display adjustment signal on a next horizontal scanning line at the same timing. The detection/decision part 3 performs sampling, while shifting the sampling timing for two horizontal scanning lines each by a predetermined interval ΔTS. The detection/decision part 3 performs a plurality of sequential calculations of the sampled value of the display adjustment signal and the differential value between the display adjustment signal and a next display adjustment signal having an inverted signal-level. The detection/decision part 3 detects the optimum timing by detecting the timing of the display adjustment signal having the maximum value (i.e., maximum contrast) of a plurality of calculated differential values. The sampling interval ΔTS may be fixed or appropriately settable by the operating part or the like.

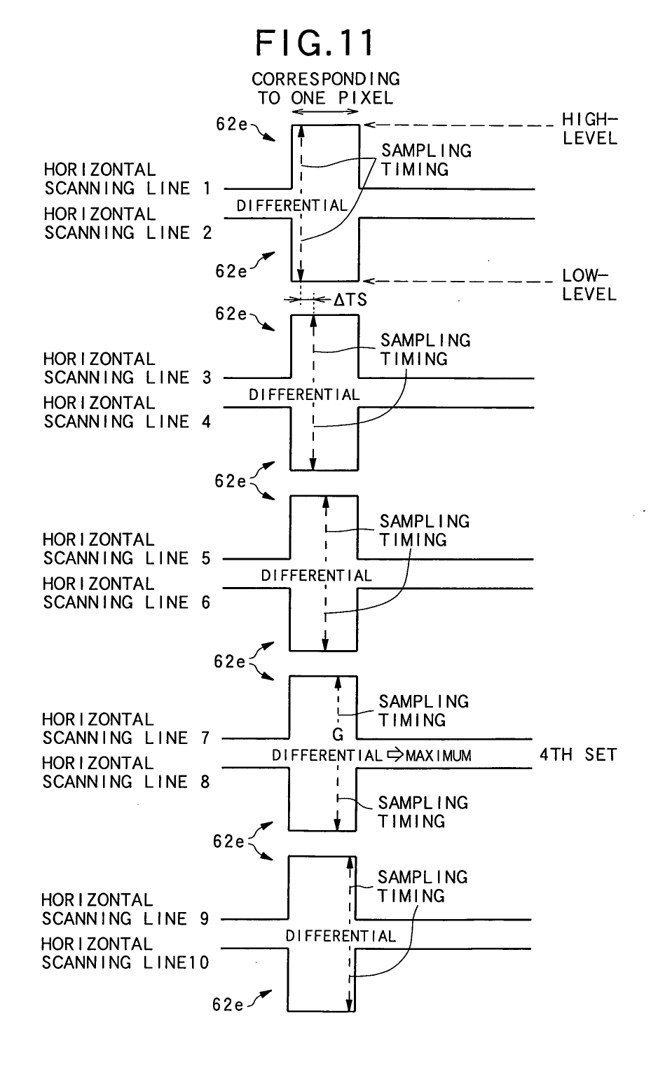

FIG. 11 is an illustration showing another example of the sampling timing and the optimum timing of the display adjustment signal for use in the example 4. In FIG. 11, there is shown a display adjustment signal 62e having no rounding. However, the display adjustment signal 62e actually has rounding in the same manner as the display adjustment signals shown in FIG. 4 and other drawings.

In the example shown in FIG. 11, one portion of each of the display adjustment signals 62e superimposed upon the signal portion on ten horizontal scanning lines in the above-mentioned signal portions is used as a sampling point. The sampling timing for every two horizontal scanning lines is shifted by the predetermined interval ΔTS. For example, the optimum timing is the timing G, and the differential value between the sampled values of the High-level and Low-level display adjustment signals 62e of the fourth set is the maximum value (i.e., maximum contrast).

As described above, the display control device SX1 of the above-mentioned example 4 is configured to perform the processing which includes: the step of detecting the optimum timing based on the timing of the maximum differential value between the sampled values, rather than the step of detecting the optimum timing based on the timing of the maximum or minimum value of the sampled values of the display adjustment signal; and the step of adjusting the timing of display of each pixel of the image information in accordance with the detected optimum timing. Therefore, the display control device SX1 of the example 4 enables a match between the timing of the maximum contrast and the timing of display of each pixel and thus enables displaying a clearer image, in particular for example when the signal-level of the image signal is inverted for each horizontal scanning line.

In the above-mentioned first embodiment, the display adjustment signal is not particularly limited to a square wave but may be in the form of, for example, a sine wave or a triangular wave. In this case, the phase of the clock signal is shifted by a phase difference between the reference point (e.g., the center point) of the sine or triangular wave and the maximum point of the sine or triangular wave, as in the case of the square wave.

### Second Embodiment

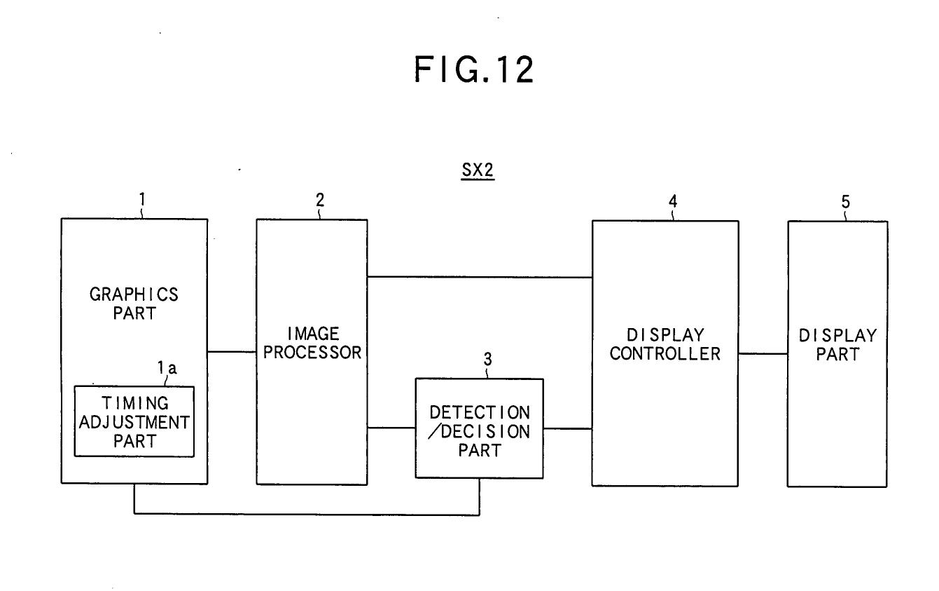

Next, the description is given with reference to FIG. 12 and other drawings with regard to the configuration and functions of a display control device included in a car navigation system according to a second embodiment of the invention. Incidentally, the same reference numerals designate the same structural components of the display control device of the second embodiment as the structural components of the display control device of the first-embodiment, and the repeated description of the same structural components is thus omitted.

FIG. 12 is a schematic block diagram showing an example of the display control device included in the car navigation system according to the second embodiment.

As shown in FIG. 12, a display control device SX2 according to the second embodiment includes the graphics part 1, the image (or picture) processor 2, the detection/decision part 3, the display controller 4, and the display part 5, as in the case of the display control device SX1 according to the first embodiment. However, the display control device SX2 is different from the display control device SX1 of the first embodiment in that the graphics part 1 has a timing adjustment part la which acts as an example of the adjusting device.

The graphics part 1 performs the same function as the graphics part 1 of the first embodiment. Furthermore, the timing adjustment part 1a adjusts the timing of output of an image signal having a display adjustment signal superimposed thereon in accordance with optimum timing detected by the detection/decision part 3. The timing adjustment part 1a adjusts the timing of output of the image signal in order to adjust the timing of display of each pixel of image information, as in the case of the timing adjustment part 4a of the first embodiment which adjusts the phase of the clock signal in order to adjust the timing of display of each pixel.

The functions of the image processor 2 and the detection/decision part 3 of the second embodiment are the same as those of the first embodiment. Specifically, the detection/decision part 3 detects the optimum timing based on a plurality of sampled values, employing any of the approaches discussed by referring to the examples 1 to 4 of the first embodiment.

The display controller 4 of the second embodiment does not perform adjustment of the phase of the clock signal, although the functions of the display controller 4 and the display part 5 of the second embodiment are substantially the same as those of the first embodiment.

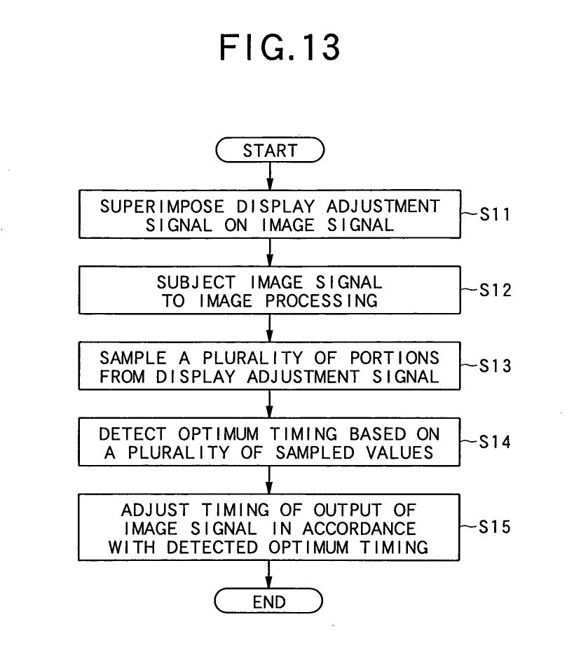

Next, the description is given in the sections “Example 5” to “Example 8” with reference to FIG. 13 and other drawings with regard to the operation of the display control device SX2 having the above-mentioned configuration. FIG. 13 is a flowchart showing the flow of processing which the display control device SX2 performs (incidentally, the flowchart of FIG. 13 is common to the examples 5 to 8). Incidentally, minimized is the description of the same operation of the display control device SX2 of the second embodiment as the operation of the display control device SX1 of the first embodiment.

### Example 5

The example 5 corresponds to the example 1 of the first embodiment.

Steps S11 to S13 of the example 5 shown in FIG. 13 are the same as steps S1 to S3 of the example 1 shown in FIG. 3, respectively.

In step S14 of the example 5, the detection/decision part 3 detects the optimum timing by detecting the timing of the display adjustment signal having the maximum or minimum value of a plurality of sampled values (as in the case of the first embodiment). The detection/decision part 3 outputs the dot clock phase adjustment signal indicative of the detected optimum timing to the graphics part 1 rather than the display controller 4.

Upon receipt of the image signal, the horizontal and vertical synchronization signals, and other signals from the image processor 2 and the detection/decision part 3, the display controller 4 outputs these input signals to the display part 5.

In step S15 of the example 5, the timing adjustment part la of the graphics part 1 then adjusts the timing of output of the image signal in accordance with the clock phase adjustment signal from the detection/decision part 3 in order to bring the timing of each pixel signal having the maximum value into synchronization with the clock signal.

For example, this adjustment is such that the phase of the image signal shown in FIG. 5A is shifted by the phase difference ΔT between the timing of the reference point of the display adjustment signal 62 and the detected optimum timing, that is, such that the timing of output of the image signal is output earlier than the unadjusted timing by the phase difference ΔT.

In the example 5, the clock signal shown in FIG. 5D is not used.

Then, the display part 5 receives the clock signal (e.g., the clock signal shown in FIG. 5C) in synchronization with the timing of each pixel signal 61, of the image information contained in the image signal, having the maximum value. The horizontal and vertical drivers drive the pixels on each line on the liquid crystal panel in synchronization with the clock signal. Thus, the display screen of the liquid crystal panel displays clear image information.

As described above, the display control device SX2 of the above-mentioned example 5 is configured to perform the processing which includes the steps of: sampling a plurality of portions from the display adjustment signal superimposed on the image signal; detecting the timing of the display adjustment signal having the maximum or minimum value of a plurality of sampled values, thereby detecting the optimum timing; and adjusting the timing of output of the image signal in accordance with the detected optimum timing, thereby adjusting the timing of display of each pixel of the image information. Therefore, as in the case of the display control device SX1 of the example 1, the display control device SX2 of the example 5 enables a more exact match between the timing of output of the image signal from the graphics part 1 and the timing of display of each pixel on the display part and thus enables displaying a clearer image, even when the image signal is delayed or is rounded or otherwise distorted under the influence of, for example, the length of the transmission line, the frequency characteristics of the transmission line, or the like. Moreover, the display control device SX2 of the example 5 allows sampling a plurality of portions from a 1-pulse display adjustment signal in synchronization with a graphic dot, and thus enables detecting the optimum timing with greater precision.

### Example 6

The example 6 corresponds to the example 2 of the first embodiment. Specifically, in the example 6, the detection/decision part 3 detects the optimum timing through the procedure which involves detecting the timing of the display adjustment signal having the maximum or minimum value, and detecting the timing at which the display adjustment signal is shifted in phase from the detected timing by a predefined amount of offset.

The processing shown in FIG. 13 is applied to processing which the display control device SX2 of the example 6 performs. Steps S11 to S13 shown in FIG. 13 take place as in the case of the example 5.

In step S14 of the example 6, the detection/decision part 3 detects the optimum timing through the procedure which involves detecting the timing of the display adjustment signal having the maximum (or minimum) value of a plurality of sampled values, and detecting the timing at which the display adjustment signal is shifted in phase from the detected timing by a predefined amount of offset. The detection/decision part 3 outputs to the graphics part 1 the dot clock phase adjustment signal indicative of the detected optimum timing, as in the case of the example 5.

Step S15 of the example 6 is the same as that of the example 5.

As described above, the display control device SX2 of the above-mentioned example 6 is configured to perform the processing which includes the steps of: sampling a plurality of portions from the display adjustment signal superimposed on the image signal; detecting the timing of the display adjustment signal having the maximum or minimum value of a plurality of sampled values, and detecting the timing at which the display adjustment signal is shifted in phase from the detected timing by a predefined amount of offset, thereby detecting the optimum timing; and adjusting the timing of output of the image signal in accordance with the detected optimum timing, thereby adjusting the timing of display of each pixel of the image information. Therefore, the display control device SX2 of the example 6 enables a more exact match between the timing of output of the image signal from the graphics part 1 and the timing of display of each pixel on the display part, and thus enables displaying a clearer image, even when the image signal is delayed or is rounded or otherwise distorted under the influence of, for example, the length of the transmission line, the frequency characteristics of the transmission line, or the like, and moreover when it is not appropriate to use as the optimum timing the timing of the display adjustment signal having the maximum or minimum value under the influence of the above situations (i) to (iii) in the example 2, and so on.

### Example 7

The example 7 corresponds to the example 3 of the first embodiment. Specifically, in the example 7, the detection/decision part 3 samples respective portions of a plurality of pulses from a multi-pulse signal, and detects the optimum timing based on a plurality of sampled values.

The processing shown in FIG. 13 is applied to processing which the display control device SX2 of the example 7 performs. Steps S11 to S13 of the example 7 shown in FIG. 13 are the same as steps S1 to S3 of the example 3 shown in FIG. 3, respectively.

Steps S14 and S15 of the example 7 are the same as those of the example 5.

As described above, the display control device SX2 of the above-mentioned example 7 is configured to perform the processing which includes: the step of sampling at least one portion from each of a plurality of display adjustment signals while shifting the sampling timing, rather than the sampling step of the examples 5 and 6, specifically the step of sampling a plurality of portions from the display adjustment signal corresponding to one display pixel; the step of detecting the optimum timing based on a plurality of sampled values; and the step of adjusting the timing of output of the image signal in accordance with the detected optimum timing, thereby adjusting the timing of display of each pixel of the image information. Therefore, as in the case of the display control device SX1 of the example 3, the display control device SX2 of the example 7 enables a more exact match between the timing of output of the image signal from the graphics part 1 and the timing of display of each pixel for the display part, and thus enables displaying a clearer image. Moreover, the display control device SX2 of the example 7 can increase the sampling interval or increase the number of samplings, and can thus reduce load on the detection/decision part 3 or the like.

### Example 8

The example 8 corresponds to the example 4 of the first embodiment. Specifically, in the example 8, the detection/decision part 3 samples a portion from the display adjustment signal in each of High-level and Low-level intervals having the same interval, then calculates the differential value between the sampled value in the High-level interval and the sampled value in the Low-level interval, and then detects the optimum timing by detecting the timing of the display adjustment signal having the maximum value of a plurality of calculated differential values.

The processing shown in FIG. 13 is applied to processing which the display control device SX2 of the example 8 performs. Steps S11 to S13 of the example 8 shown in FIG. 13 are the same as steps S1 to S3 of the example 4 shown in FIG. 3, respectively.

In step S14 of the example 8, the detection/decision part 3 calculates the differential value between the sampled values in the High-level and Low-level intervals of each set, and detects the optimum timing by detecting the timing of the display adjustment signal having the maximum value (i.e., maximum contrast) of a plurality of calculated differential values. The detection/decision part 3 outputs to the graphics part 1 the dot clock phase adjustment signal indicative of the detected optimum timing.

As in the case of the example 4, the detection/decision part 3 may be configured to detect the optimum timing through the procedure which involves detecting the timing of the display adjustment signal having the maximum value of a plurality of calculated differential values, and detecting the timing at which the display adjustment signal is shifted in phase from the detected timing by a predefined amount of offset.

Step S15 of the example 8 is the same as that of the example 5.

As described above, the display control device SX2 of the above-mentioned example 8 is configured to perform the processing which includes: the step of detecting the optimum timing based on the timing of the maximum differential value between the sampled values, rather than the step of detecting the optimum timing based on the timing of the maximum or minimum value of the sampled values of the display adjustment signal; and the step of adjusting the timing of output of the image signal in accordance with the detected optimum timing, thereby adjusting the timing of display of each pixel of the image information. Therefore, as in the case of the display control device SX1 of the example 4, the display control device SX2 of the example 8 enables a match between the timing of the maximum contrast and the timing of display of each pixel and thus enables displaying a clearer image, in particular, for example, when the signal-level of the image signal is inverted on each horizontal scanning line.

In the above-mentioned second embodiment, the display adjustment signal is not particularly limited to a square wave but maybe in the form of, for example, a sine wave or a triangular wave.

In the above-mentioned second embodiment, the graphics part 1 is configured to adjust the timing of output of the image signal. However, a part other than the graphics part 1, such as the image processor 2, the detection/decision part 3, or the display controller 4, may be configured to adjust the timing of output of the image signal so as to bring the clock signal into synchronization with the timing of each pixel signal having the maximum value.

In the above-mentioned first and second embodiments, the graphics part 1, the image processor 2, the detection/decision part 3, and the display controller 4 maybe implemented in hardware such as comparator and logic circuits, both of which comprise semiconductor devices or the like. Alternatively, these structural parts may be wholly or partially implemented in software which is executable by a CPU (central processing unit). Specifically, a display control program may be executed by the CPU so as to function as the display adjustment signal superimposing device, the detecting device and the adjusting device of the invention. In this instance, the display control program may be prestored in a storage or memory such as a ROM (read only memory), may be downloaded from a server connected to a network such as the Internet into the storage or memory, or may be read from a flexible disk or the like into the storage or memory.

In the above-mentioned first and second embodiments, the display adjustment signal maybe superimposed on an image signal corresponding to any of RGB color components. Alternatively, the display adjustment signal may be superimposed on a signal other than an image signal corresponding to any of RGB color components, such as a luminance signal (in the case of YUV), a synchronization signal (e.g., a vertical or horizontal synchronization signal), or a composite signal.

In the above-mentioned first and second embodiments, the display adjustment signal is superimposed upon the image signal on the horizontal scanning line in the signal portion which corresponds to the region outside the display screen of the display part 5 and also corresponds to the region capable of displaying the image information. However, the display adjustment signal is not limited to being superimposed in this manner. For example, the display adjustment signal may be superimposed on a signal portion on a horizontal scanning line within a vertical retrace interval corresponding to the region which lies both outside the available-for-graphics area 52 and inside the signal area 53 and does not contribute to a display image.

In the above-mentioned first and second embodiments, the display adjustment signal is superimposed on one signal (e.g., an R-component image signal). However, the display adjustment signal is not limited to being superimposed in this manner. The display adjustment signals may be superimposed on a plurality of signals. For example, the display control device may be configured to perform processing which includes the steps of: superimposing the display adjustment signals on all of image signals corresponding to RGB color components in synchronization with the image signals; sampling a plurality of portions from each of the display adjustment signals; detecting the timing of the display adjustment signal having the maximum value of all sampled values (e.g., the timing at which the display adjustment signal corresponding to the G component, of the display adjustment signals corresponding to the RGB color components, has the maximum value); and adjusting the timing of display of each pixel of the image information in accordance with the detected timing, as mentioned above.

For example, the display control device may be configured to perform processing which includes the steps of: superimposing the display adjustment signals on all of image signals corresponding to RGB color components in synchronization with the image signals; sampling a plurality of portions from each of the display adjustment signals; detecting the maximum value of a plurality of sampled values for each image signal, and detecting the timing of the mean of the detected values; and adjusting the timing of display of each pixel of the image information in accordance with the detected timing, as mentioned above. With this configuration, the display control device can achieve a match between the display timings of images of the image signals, for example, even when the pixel signals of the image signals have different maximum values, because the frequency characteristics vary among the image signals.

For example, the display control device may be configured to perform processing which includes the steps of: superimposing the display adjustment signals on all of image signals corresponding to RGB color components in synchronization with the image signals; sampling a plurality of portions from each of the display adjustment signals; detecting the timing of the display adjustment signal having the maximum value for each image signal; and adjusting the timing of display of each pixel of each image signal in accordance with the timing detected for each image signal. In other words, the display control device adjusts the phase of the image signal corresponding to each color component in accordance with one of the timings detected for the respective image signals so that the timings at which the display adjustment signals superimposed on the image signals have the maximum value match one another. With this configuration, the display control device can match the timings of the pixel signals having the maximum value, and thus enables displaying still clearer image information, for example, even when the timings at which the pixel signals of the image signals have the maximum value are somewhat different, because the frequency characteristics vary among the image signals.

In the above-mentioned first and second embodiments, the detection/decision part 3 is located between the image processor 2 and the display controller 4. For example, the detection/decision part 3, however, may be located between the display controller 4 and the display part 5.

In the above-mentioned first and second embodiments, the invention is applied to the car navigation system. However, the invention is not limited to the car navigation system but maybe applied to a display device which displays a TV (television) picture, a video picture, or the like. To process an analog signal such as a TV picture, the display adjustment signal is superimposed upon the image signal on the horizontal scanning line in the signal portion which corresponds to the region outside the display screen of the display part 5 and also corresponds to the region capable of displaying the image information, as mentioned above.

In the above-mentioned first and second embodiments, the liquid crystal panel is applied to the display screen as an example. However, the display screen is not limited to the liquid crystal panel. Any panel may be applied to the display screen, provided that it has a display screen capable of pixel display, such as a plasma display (PDP), an organic EL (electroluminescent) panel, or a CRT (cathode ray tube).

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-415454 filed on Dec. 12, 2003 including the specification, claims, drawings and abstract is incorporated herein by reference in its entirety.

1. A display control device which permits a display screen to display predetermined image information, comprising:
a detecting device which receives a signal having a display adjustment signal superimposed thereon, samples a plurality of portions from the display adjustment signals, and detects optimum timing based on a plurality of sampled values, the display adjustment signal being used for adjusting the timing of display of each pixel of the image information, the display adjustment signal being superimposed upon the signal on a horizontal scanning line in a signal portion corresponding to a region outside the display screen; and
an adjusting device which adjusts the timing of display of each pixel in accordance with the detected optimum timing.

2. The display control device according to claim 1 further comprising a display adjustment signal superimposing device which superimposes the display adjustment signal upon the signal on the horizontal scanning line in the signal portion corresponding to the region outside the display screen, and outputs the signal.

3. The display control device according to claim 2, wherein the adjusting device adjusts the timing of output of the signal having the display adjustment signal superimposed thereon.

4. The display control device according to claim 1, wherein the adjusting device adjusts the phase of a clock signal for regulating the timing of display of each pixel.

5. The display control device according to claim 1, wherein the adjusting device adjusts the phase of the clock signal by shifting the phase of the clock signal by a phase difference between the timing of a reference point of the display adjustment signal and the detected optimum timing.

6. The display control device according to claim 1, wherein the adjusting device adjusts the timing of display of each pixel by shifting the timing of display of each pixel by a phase difference between the timing of the reference point of the display adjustment signal and the detected optimum timing.

7. The display control device according to claim 1, wherein the detecting device samples a plurality of portions from the display adjustment signals, and detects the optimum timing by detecting the timing of the display adjustment signal having the maximum or minimum value of a plurality of sampled values.

8. The display control device according to claim 1, wherein the detecting device samples a plurality of portions from the display adjustment signals, detects the timing of the display adjustment signal having the maximum or minimum value of a plurality of sampled values, and detects the timing at which the display adjustment signal is shifted in phase from the detected timing by a predefined amount of offset, thereby detecting the optimum timing.

9. The display control device according to claim 7, wherein the display adjustment signal has a plurality of repetitions of HIGH and LOW levels, and
the detecting device samples at least one portion in each High-level interval from the display adjustment signal, and the detecting device performs sampling, while shifting the sampling timing for each High-level interval by a predetermined interval.

10. The display control device according to claim 7, wherein the display adjustment signal has a plurality of repetitions of HIGH and LOW levels, and
the detecting device samples at least one portion in each Low-level interval from the display adjustment signal, and the detecting device performs sampling, while shifting the sampling timing for each Low-level interval by a predetermined interval.

11. The display control device according to claim 7, wherein the plurality of display adjustment signals are superimposed upon the signal portion on a plurality of horizontal scanning lines corresponding to one screen, and
the detecting device samples at least one portion from each of the display adjustment signals, and the detecting device performs sampling, while shifting the sampling timing for each display adjustment signal by a predetermined interval.

12. The display control device according to claim 7, wherein the display adjustment signals are superimposed on all of image signals corresponding to color components contained in the image information in synchronization with the image signals, and
the detecting device samples a plurality of portions from each of the display adjustment signals superimposed on the image signals, and detects the optimum timing by detecting the timing of the display adjustment signal having the maximum or minimum value for each image signal.

13. The display control device according to claim 7, wherein the display adjustment signals are superimposed on all of image signals corresponding to color components contained in the image information in synchronization with the image signals, and
the detecting device samples a plurality of portions from each of the display adjustment signals superimposed on the image signals, and detects the optimum timing by detecting the timing of the display adjustment signal having the maximum or minimum value of a plurality of sampled values for all the image signals.

14. The display control device according to claim 7, wherein the display adjustment signals are superimposed on all of image signals corresponding to color components contained in the image information in synchronization with the image signals, and
the detecting device samples a plurality of portions from each of the display adjustment signals superimposed on the image signals, detects the maximum or minimum value of a plurality of sampled values for each image signal, and detects the timing of the mean of the detected values, thereby detecting the optimum timing.

15. The display control device according to claim 1, wherein the display adjustment signal has a plurality of repetitions of HIGH and LOW levels having the same interval,
the detecting device performs sampling on each set of HIGH and LOW levels so as to sample at least one portion in the High-level interval and a portion distant from the one portion by a given interval in the Low-level interval following the High-level interval, and the detecting device performs sampling, while shifting the sampling timing for each set by a predetermined interval, and
the detecting device calculates the differential value between the sampled values in the High-level and Low-level intervals of each set, and detects the optimum timing by detecting the timing of the display adjustment signal having the maximum value of a plurality of calculated differential values.

16. The display control device according to claim 1, wherein the display adjustment signals, each of which has an inverted signal-level on each horizontal scanning line, are superimposed upon the signal portion on a plurality of horizontal scanning lines corresponding to one screen,
the detecting device samples at least one portion from the display adjustment signal on one horizontal scanning line and also samples a portion from the display adjustment signal on a next horizontal scanning line at the same timing, and the detecting device performs sampling, while shifting the sampling timing for every two horizontal scanning lines by a predetermined interval, and
the detecting device performs a plurality of calculations of the sampled value of the display adjustment signal and the differential value between the display adjustment signal and the next display adjustment signal having an inverted signal-level, and detects the optimum timing by detecting the timing of the display adjustment signal having the maximum value of a plurality of calculated differential values.

17. The display control device according to claim 1, wherein the display adjustment signal is superimposed upon the image signal on the horizontal scanning line in the signal portion which corresponds to the region outside the display screen and also corresponds to the region capable of displaying the image information.

18. The display control device according to claim 1, wherein the display adjustment signal is to be superimposed on at least one of an image signal corresponding to any of color components contained in the image information, a luminance signal, and a synchronization signal.

19. The display control device according to claim 1, wherein the display adjustment signal comprises at least one of a square wave, a sine wave, and a triangular wave.

20. The display control device according to claim 1, wherein the display adjustment signal is in synchronization with a graphic dot.

21. The display control device according to claim 1, wherein the display adjustment signal corresponds to one display pixel.

22. A display control method which permits a display screen to display predetermined image information, comprising:
a detecting process which receives a signal having a display adjustment signal superimposed thereon, samples at least one portion from the display adjustment signal, and detects optimum timing based on the sampled value, the display adjustment signal being used for adjusting the timing of display of each pixel of the image information, the display adjustment signal being superimposed upon the signal on a horizontal scanning line in a signal portion corresponding to a region outside the display screen; and
an adjusting process which adjusts the timing of display of each pixel in accordance with the detected optimum timing.

23. A recording medium which records a computer-readable display control program which runs on a computer which permits a display screen to display predetermined image information,
the display control program which permits the computer to execute a display control method comprising:
a detecting process which receives a signal having a display adjustment signal superimposed thereon, samples at least one portion from the display adjustment signal, and detects optimum timing based on the sampled value, the display adjustment signal being used for adjusting the timing of display of each pixel of the image information, the display adjustment signal being superimposed upon the signal on a horizontal scanning line in a signal portion corresponding to a region outside the display screen; and
an adjusting process which adjusts the timing of display of each pixel in accordance with the detected optimum timing.
